(19) United States
(12) Patent Application Publication
(10) Pub. No.: US 2015/0267901 A1
(43) Pub. Date: Sep. 24, 2015

(54) ROTATING LAMP WITH EXCHANGEABLE PANELS

(71) Applicants: Drew Cohen, Kings Park, NY (US); Eric Mingrino, Middle Village, NY (US)

(72) Inventors: Drew Cohen, Kings Park, NY (US); Eric Mingrino, Middle Village, NY (US)

(21) Appl. No.: 14/217,736

(22) Filed: Mar. 18, 2014

(51) Int. Cl. F21V 17/10; F21V 17/02

(52) U.S. Cl. CPC F21V 17/107; F21V 17/02

(57) ABSTRACT

A lamp with a head freely rotatable above a base is provided. Preferably both the head and base are made of several panels interconnected with hinges. The panels forming the head include a frame with tabs defining a slot for inserts. The inserts are transparent or translucent and bear decorative designs. A low heat highly efficient light bulb is used as a light source. The various elements are preferably shipped in a single box and are arranged and constructed so that they can be readily assembled to form the lamp without any tools required.

### RELATED APPLICATIONS

The subject matter of this application is related to U.S Design Patent application S.N. ______ entitled A FRAME FOR A LAMP filed on even date herewith, now ______; and U.S Design Patent application S.N. ______entitled A DESK LAMP filed on even date herewith, now ______, all incorporated herein by reference.

### BACKGROUND OF THE INVENTION

1. Field of Invention

This invention pertains to a decorative lamp that having several replaceable panels. The panels are preferably provided on a rotatable lamp head and arranged in a geometric configuration.

2. Description of the Prior Art

Lamps are an important and common means of providing decorations as well as lighting in many areas, including residential, commercial and industrial environments. A typical lamp includes a base, a light fixture holding a light bulb or other light source and a decorative covering that covers the light source so that the lamp is more esthetically pleasing. While millions of such lamps are sold all over the world, a problem with most of them is that decorative covering is fixed and hence a lamp cannot be changed to match changes in the decorative styles of a room or environment without changing the whole lamp or taking the whole lamp apart.

A further problem is that typically lamps are fairly fragile and cannot be readily dismantled and reassembled. As a result, they must be shipped in bulky boxes with various protective means, such as Styrofoam padding, plastic bags, loose paper, etc.

The present application describes a lamp that provides solutions to these problems.

### SUMMARY OF THE INVENTION

A lamp is disclosed formed of several interconnected panels defining a lamp head shaped as a polygon. The panels are connected by pins and are arranged so that they can be easily taken apart and reassembled. A light source, such as a high efficiency LED light bulb is positioned within the polygon to generate light. The panels have decorative openings, or, preferably, inserts with various designs that can be readily slipped in and out. A top is mounted on top of the panels and preferably includes its own decorative panel having a matching pattern to the pattern on the other inserts.

A base may also be provided. In one embodiment the base is also made of panels that are hingedly interconnected. A support, such as a tubular member extends upwardly of the base to support the light source within the polygon. The head may be rotatably rested on the support.

The various elements of the lamp can be readily stored and shipped in a small box. A customer can then assemble the lamp quickly and easily by interconnecting the panels, slipping the inserts into the panels and mounting the light bulb, or without the need of any tools.

### BRIEF DESCRIPTION OF THE DRAWINGS

FIG. 1 shows an orthogonal elevational view of a lamp constructed in accordance with this invention;

FIG. 2 shows a top view of the lamp head;

FIG. 3 shows a front elevational view of the lamp;

FIG. 4 shows a bottom view of the lamp

FIG. 5 shows an elevational cross sectional view of the lamp;

FIG. 6 shows a bottom view of the lamp;

FIG. 7 shows a cross-sectional view of a light bulb and its socket used in the lamp of FIGS. 1-6;

FIG. 8 shows a partial view of two panels forming the lamp, the panels being joined by a pin;

FIG. 9 shows an orthogonal view of the frame for the lamp;

FIG. 10 shows a front elevational view of the frame for the lamp;

FIG. 11 shows a top view of the frame;

FIG. 12 shows a rear or inside elevational view of the frame;

FIG. 12A shows a side view of the frame

FIG. 13 shows a bottom view of the frame;

FIG. 13A shows an orthogonal view of a panel forming the base for the lamp;

FIG. 13B shows an orthogonal view of the brace for the base;

FIG. 13C shows a tubular member for the support;

FIG. 14 shows an orthogonal elevational view of a different embodiment of a head in which panels with cutouts are provided;

FIGS. 15A-15F show in a somewhat diagrammatical format top views of various lamp heads arranged in various geometric configurations; and

FIG. 16 shows an embodiment in which several interconnected panels are arranged by themselves on a flat surface rather than being closed to form a lamp head.

### DETAILED DESCRIPTION OF THE INVENTION

Referring to the Figures, a lamp 10 constructed in accordance with this invention includes a base 12, a support 14 and a head 20. In one embodiment, the base 12 is configured to rest on a flat surface, such as table or other furniture. In another embodiment, the base is omitted and the support 14 is configured for mounting the lamp on a vertical surface, such as a wall or a vertical beam. In this case, the support 14 may be L-shaped.

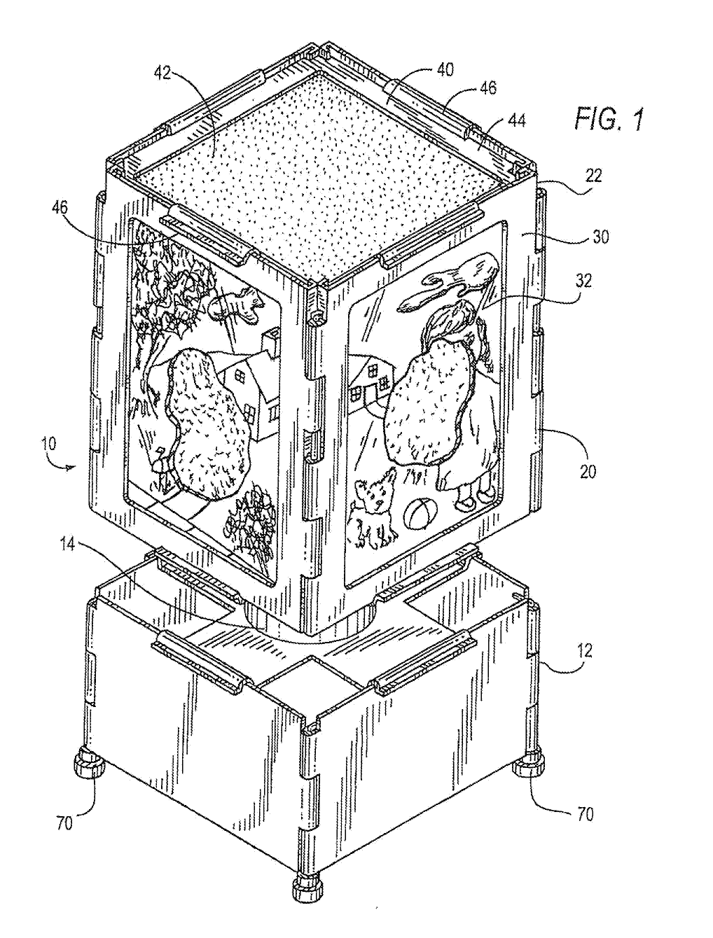

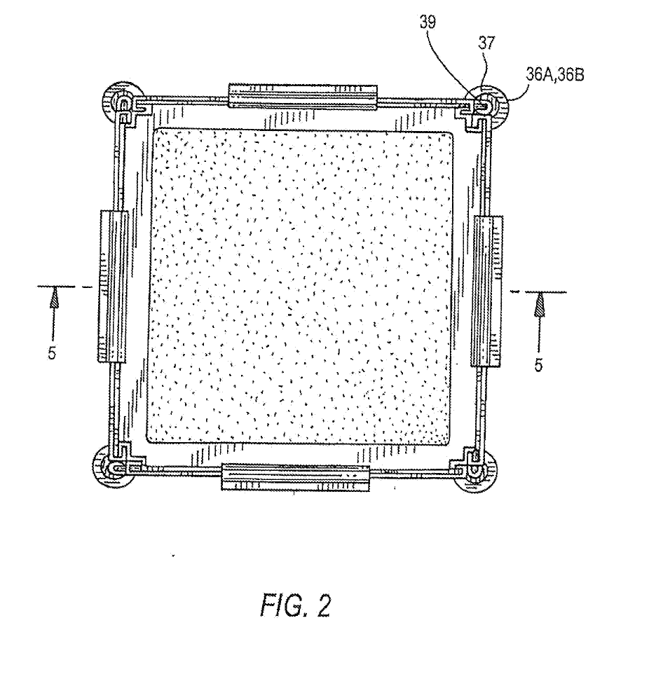

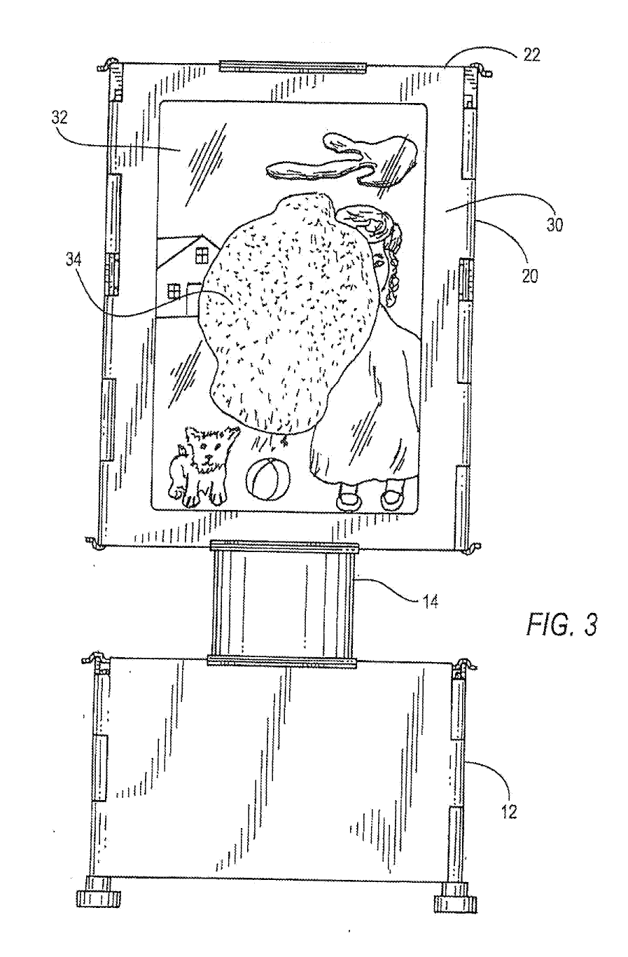

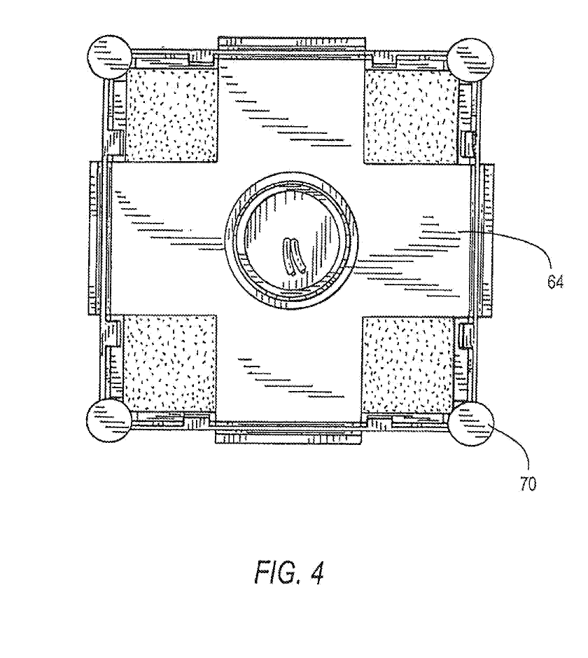

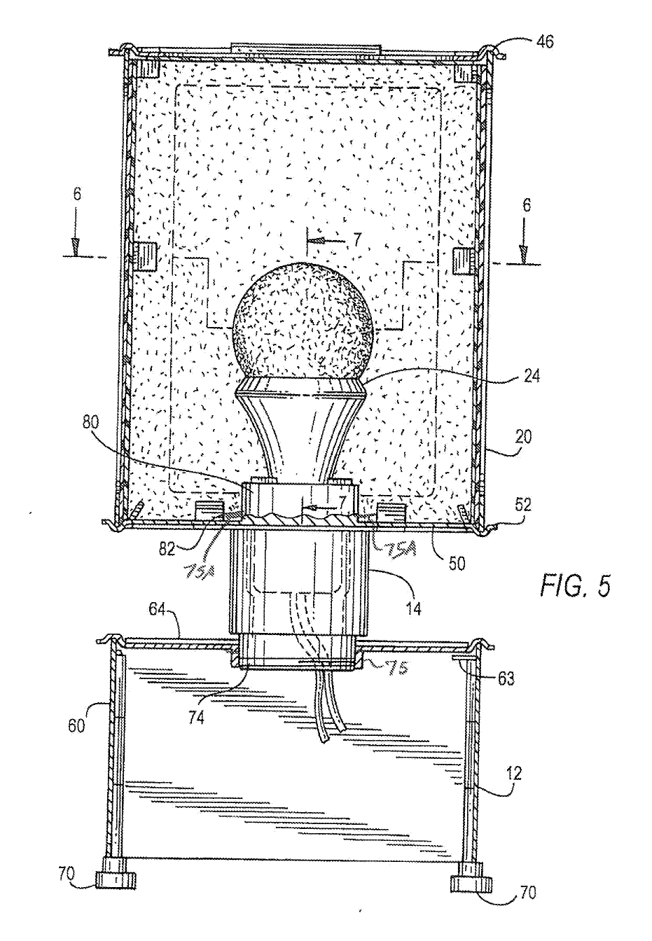

The lamp head 20 includes several, preferably identical, panels 22. The panels 22 are hingedly connected to each other long their vertical sides as discussed in more detail below, mounted by conventional braces to the support 14, and a light source 24 (seen in FIG. 5). In the embodiment shown in FIGS. 1-4, the head 20 is formed of four panels 22 interconnected and arranged to form a square.

It should be understood that the lamp is either battery powered or, more conventionally, it is connected to AC standard line by wires and a switch (not shown). The switch may be a straight on/off switch, a dimmer switch, may include a timer or may include electronics for controlling the intensity and/or the color of the light source 24. Preferably, the light source 24 generates little or no heat so that it does not affect the panel 22 and their inserts. For example, the light source may be a fluorescent light source with a spiral body. However, preferably the light source is an LED bulb having LEDs immersed in an fluid—such as the LED light bulb distributed under the name of INFINIA by Switch Lighting of San Jose, Calif. This latter light bulb is available in various ratings such as 6 W rating generating the same light as a standard 40 W incandescent bulb. Moreover, this light bulb is guaranteed for 25,000 hours.

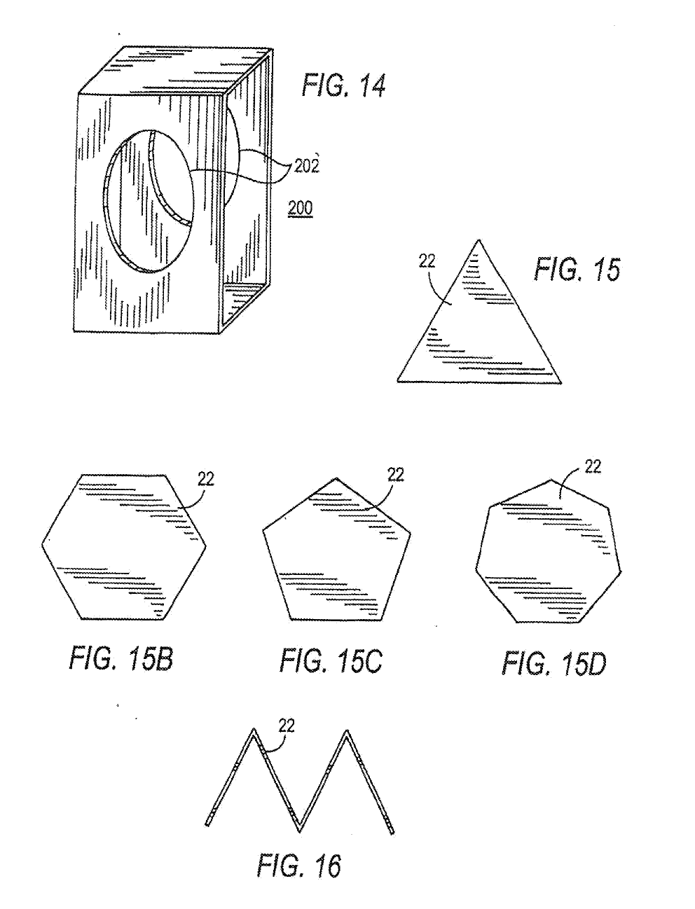

Each panel 22 consists of a frame 30 and an insert 32. The frames are made of aluminum or other light-weight durable material. The inserts 32 are made of a transparent or translucent material (such as a glass or a high impact heat resistant plastic material) to allow light from the source 24 to be emitted outwardly therethrough. Preferably the inserts 32 are provided with decorative designs, as at 34. Alternatively, the inserts may be made of an opaque or translucent material with one or more decorative cutouts 202, as shown in FIG. 14 for head 200.

The purpose of inserts 32 is to provide a unique decorative look to lamp 10. In the embodiment of Figs. each of the panels 22 is provided with its own insert 32 bearing the same or a different design 34. In addition, as described in more detail, the head 20 includes a top 40 with its own insert 42 having a design 44 that may match the designs 34 or can be different. When the light source 24 is on, it provides light beams that pass through and illuminate the inserts 32, 42. Importantly, many different panels with various designs can be provided and inserted into the frames as discussed below. Thus once a user buys lamp 10 he has many different choices for inserts 32, 42 with different designs, materials, colors, etc.

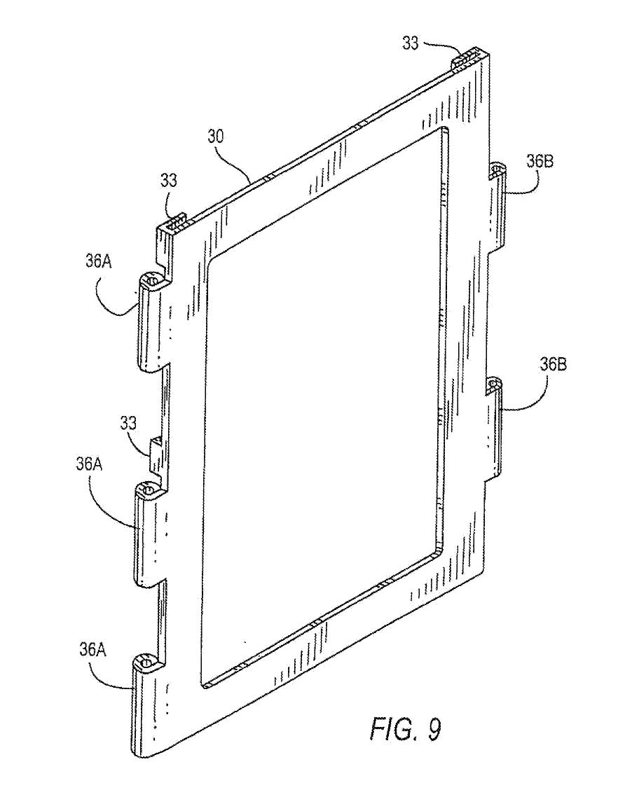

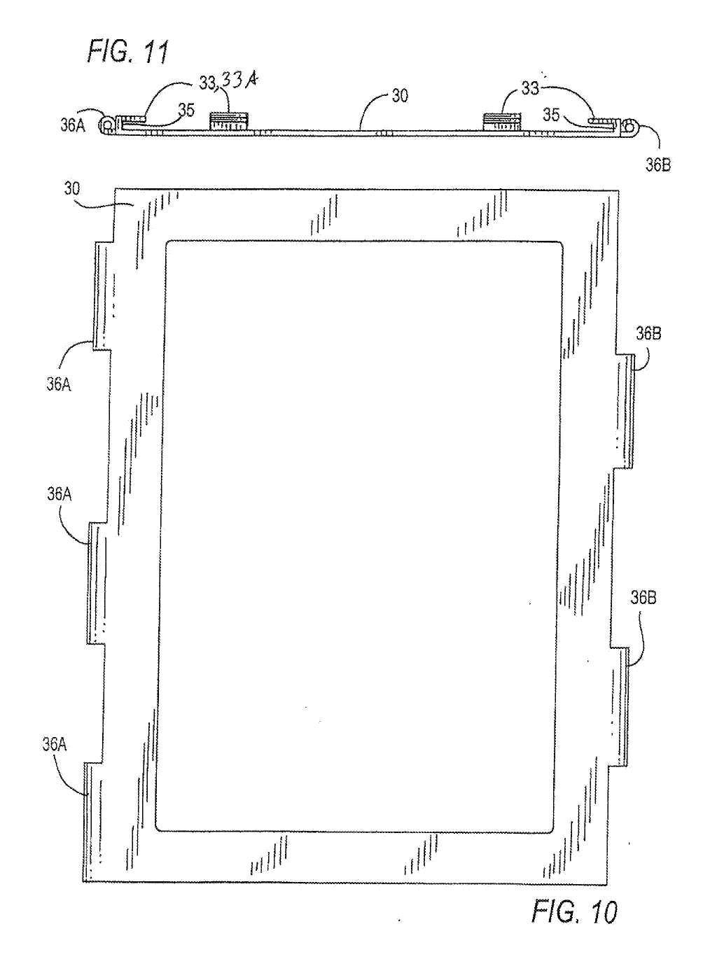

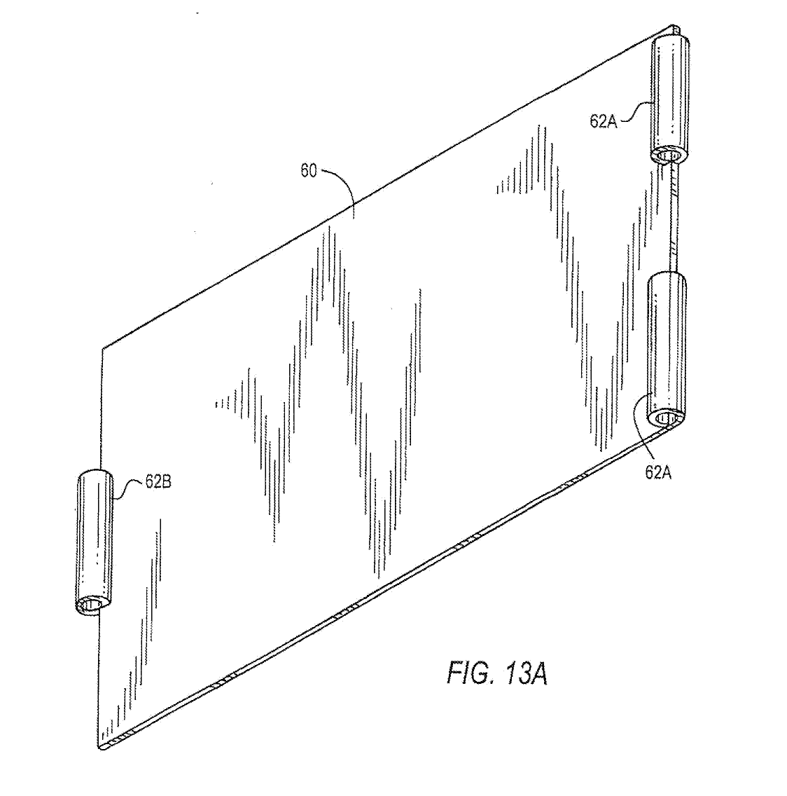

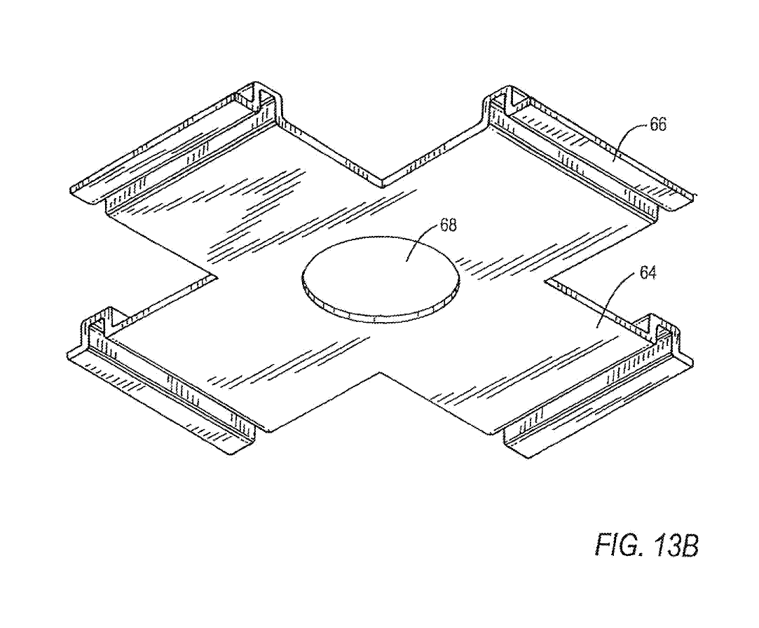

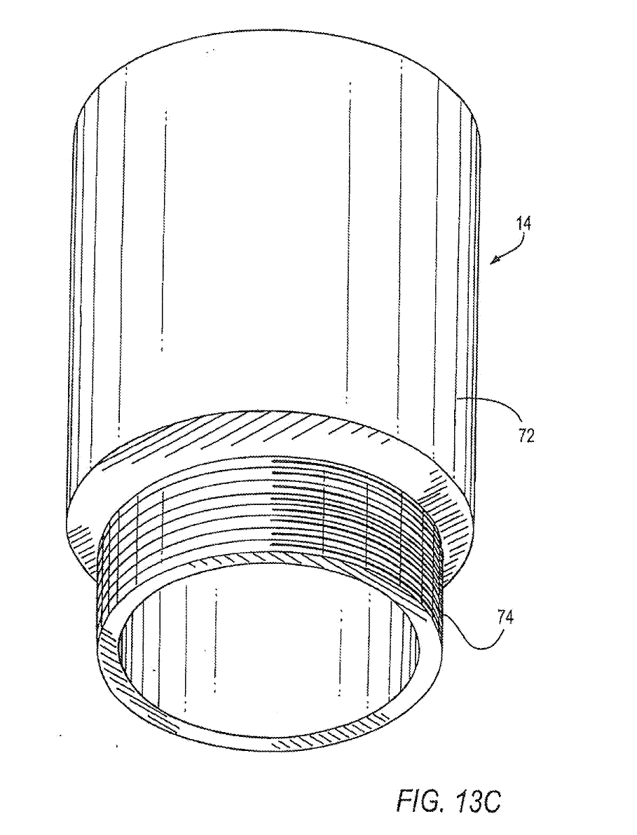

Referring now to FIGS. 8-13, each frame is formed with a central cutout 34. Around its vertical edges, the frame 30 is provided with hinging elements 36A, 36B with holes 39 arranged in a complementary configuration so that when the right edge of a frame 30 is positioned next to the left edge of an adjacent frame, the hinging elements 36A, 36B line up with holes 39 being coaxial. An L-shaped pin 61 can then be inserted into holes 39 to connect the adjacent panels. FIG. 8 shows how two frames 30A, 30B are lined up and joined by a pin 61. This configuration results in a piano-hinge type connection joining the frames.

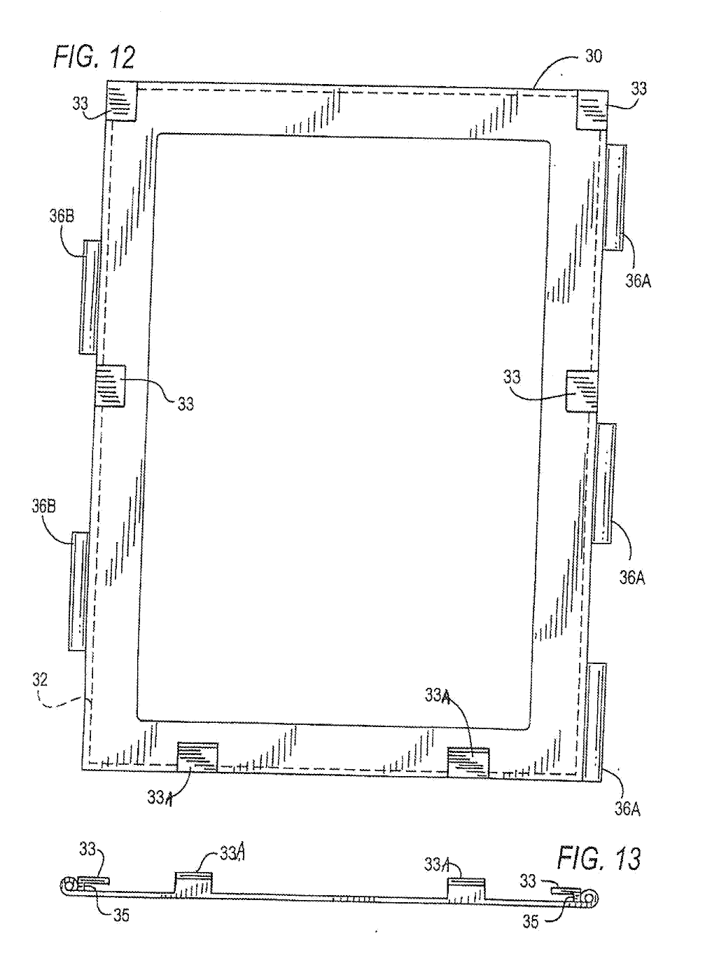

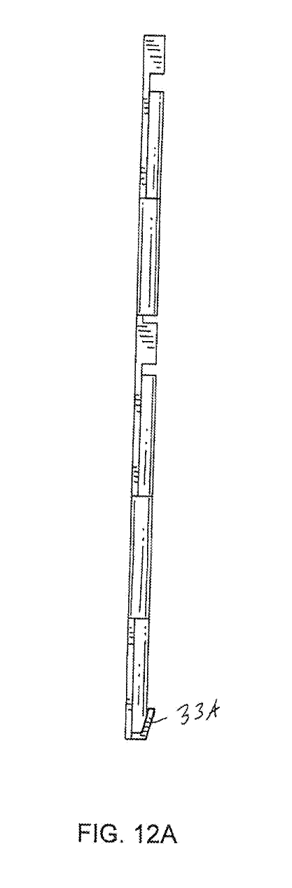

Each frame 32 is also provided with a plurality of tabs 33. The tabs 33, 33A are about ½′ long, extend about ⅛″ away from the frame 30, are generally L-shaped and are arranged and constructed to form a channel 35. No tab is required on the top edge 37 of the frames. Tabs 33 formed on the lateral sides of the frame are generally parallel to the rest of the frame 30. Tabs 33A on the bottom of the frame 30 are disposed at an angle of about 10° with respect to the plane of the frame. The inserts 32 are introduced into the channels formed by the tabs 33, 33A from the top of the frames 30 are maintained in place by the tabs. (In FIG. 12, dotted lines indicate the position of an insert 32 being held in place by tabs 33, 33A in this manner). Tabs 33A guide the insert so that it is held close to the frame.

Head 20 further includes a top 40 with an insert 42 supported by a frame 44. Frame 44 is similar to frames 30 with tabs (not shown) supporting insert 42. One difference between frame 44 and frames 30 (in addition, obvious to their shape) is that instead of hinging elements, frame 44 is formed with clips 46 that are shaped to position and hold the top 40 in the position shown (see FIG. 5). The clips may be shaped so that they grip and form an interference fit with the top edges of the frames 30 thereby further securing the top 40. It should be understood that since the frames 30 are hingedly connected, they are free to pivot with respect to each other until the lamp is assembled.

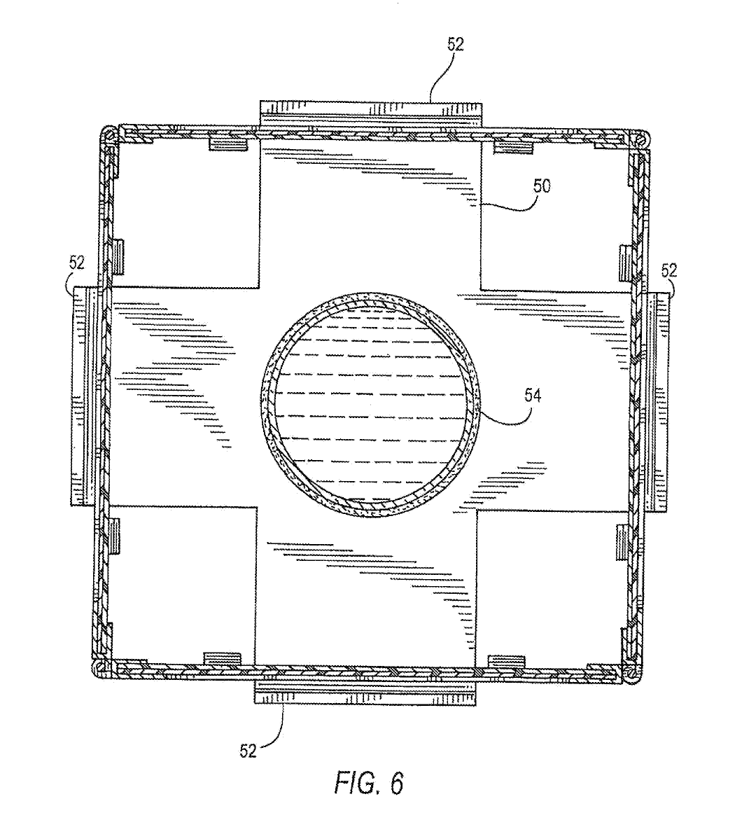

Finally, the head 20 further includes a bottom brace 50. While this brace may have various shapes, in the preferred embodiment, the brace shown in FIG. 6, is cross-shaped and has at its four edges clips 52 that engage the lower ends of the frames 30 in a manner similar to the clips 46.

Base 12 has a structure similar to the head 20. More specifically, base 12 is formed of four panels 60 as shown in FIG. 14. These panels are similar to frames 30 but do not need cutouts since they do not have an insert. The panels have hinge members 62A, 628 so that four panels 60 can be hingedly interconnected using pins 63 similar to pins 61. The four panels 60 are held in place by a top brace 64 similar in size and shape to brace 50. Brace 64 also includes clips 66 engaging the top edges of panels 60. Supporting legs 70 may be attached either directly to the panels 60 or to the interconnecting pins 63. In an alternate embodiment, instead of panels 60, frames may be used with replaceable inserts similar to the frames 30.

The support 14 includes a tubular member 72 terminating in a lower threaded end 74. The end 74 is sized and shaped to fit through 68 in brace 64. The hole 68 is threaded to receive end 74 or a threaded nut may be used to affix support 14 to brace 64.

The top of the member 72 is hollow and is sized and shaped to receive a standard electric bulb receptacle 80 with a shoulder 82 resting on cylinder 72. Preferably, the receptacle 80 is arranged to allow the brace 50 and therefore head 20 to rotate with respect to the base 12 and support 14. Therefore, the head 20 can be positioned at any angular orientation with respect to base 12.

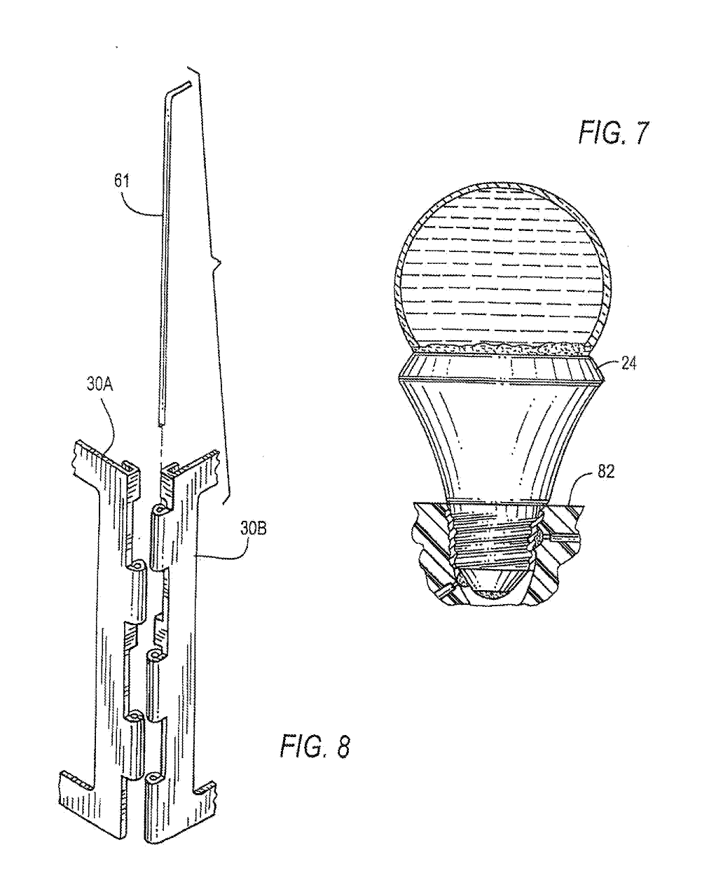

As shown in FIGS. 5 and 7, the light source 24 is screwed into standard receptacle 80.

Advantageously, the lamp 10 can be stored and shipped in a box disassembled. A buyer can then assemble the lamp by interconnecting the panels forming the base 12 and head 20 (of course, for head 20, the inserts 32, 42 are also introduced into the frames of the panels) with the respective pins, add the braces and then attach each to the support 14 with the bulb disposed within the head. The electrical wire for the bulb is threaded through the member 72 and exits through the base. It should be appreciated that this assembly can be performed quickly and easily without any special skills and without any tools. Moreover, once the lamp is assembled, not only it presents a pleasing decorative appearance that is easily customizable, but it is light yet sturdy so that it will not break easily when is turned over or falls down.

Preferably, the head 20 is not fixed to the support 14 but it is free to rotate with respect to the base 12 and the bulb with its receptacle 82. In one embodiment, a conventional motor may be mounted, for example in base 12 to drive the head.

In the Figures discussed so far, the lamp has a square or rectangular cross section. Of course, it can have other cross sections as well with 3, 5, 6 , 7 sides, etc., as illustrated in FIGS. 15A-15D. The frames 22 in each of these embodiments is made with slots for panels 32 so that they can be changed at will. In the configuration shown, the lamp can be packaged in a box 4″ in high and weighing less than 1-½ lb, thus saving shipping, storage and display space.

Finally, the panels need to be interconnected to form a closed head, but instead can be interconnected in a zig-zag shape as shown in FIG. 16. In this configuration, two or more panels with respective inserts can be interconnected and placed on a flat surface, such as table.

Numerous modifications may be made to the invention without departing from its scope as defined in the appended claims.

We claim:

1. A decorative lamp comprising:
a head including a plurality of panels arranged vertically, each panel being at least light transmissive, the panels being interconnected along their vertical edges by respective hinges to form a head polygon;
a light source disposed inside said head polygon; and
a support holding said head, said support being configured for placement on a flat surface.

2. The lamp of claim 1 wherein each panel is formed of a four sided frame and an insert disposed in the frame.

3. The lamp of claim 2 wherein each frame includes two vertical edges with hinging elements, said hinging elements receiving a pin for interconnecting the frames.

3. The lamp of claim 1 further comprising a top having a shape matching the shape and size of the polygon, said top being mounted on said panels.

4. The lamp of claim 1 further comprising a brace supporting said light source within said polygon.

5. The lamp of claim 1 further comprising a base, said base including a plurality of base panels arranged vertically and interconnected to form a base polygon.

6. The lamp of claim 5 wherein said base polygon has the same number of panels as said head polygon.

7. The lamp of claim 5 wherein said base panels are hingedly connected to each other.

8. The lamp of claim 7 wherein said base and head can be disassembled by taking said head and base apart.
